(19) United States
(12) Patent Application Publication
(10) Pub. No.: US 2025/0005883 A1
(43) Pub. Date: Jan. 2, 2025

(54) INFORMATION PROCESSING DEVICE, DISPLAY SYSTEM, AND INFORMATION PROCESSING METHOD

(71) Applicant: Sharp NEC Display Solutions, Ltd., Tokyo (JP)

(72) Inventor: Akira UCHIYAMA, Tokyo (JP)

(21) Appl. No.: 18/884,685

(22) Filed: Sep. 13, 2024

Related U.S. Application Data
(63) Continuation of application No. PCT/JP2022/013097, filed on Mar. 22, 2022.

(51) Int. Cl. G06V 10/25

(52) U.S. Cl. CPC G06V 10/25; G06V 2201/07

(57) ABSTRACT

An information processing device includes a person identifying unit configured to identify a person from a captured image obtained by imaging an imaging area, a calculation unit configured to calculate an expected value for each attribute on the basis of the number of persons for each attribute of the identified person and a reference customer transaction for each attribute, and a content identifying unit configured to identify content based on an attribute selected on the basis of the calculated expected value.

### TECHNICAL FIELD

The present invention relates to an information processing device, a display system, and an information processing method.

### BACKGROUND ART

A technique of displaying content for product advertisement on a display device and advertising products to customers is known as a technique associated with sales promotion.

Recently, a technique of analyzing information of a customer viewing an advertisement in cooperation with an imaging device using the aforementioned technique and dynamically selecting and displaying an advertisement with an effect of appeal to the customer has become known.

For example, Patent Document 1 discloses a technique of selecting content with an excellent advertising effect for a plurality of viewers when there are a plurality of viewers of a single display device. However, in the technique disclosed in Patent Document 1, for which of the plurality of viewers a sales promotion is to be performed to contribute to sales of a store and to be profitable to a seller is not controlled.

### Citation List

Patent Document

Patent Document 1

Japanese Unexamined Patent Application, First Publication No. 2020-086741

### SUMMARY OF INVENTION

### Technical Problem

There is a problem in that, when a plurality of persons are present in an imaging area, sales promotion cannot be said to be performed on a person who is most likely to be profitable to a seller.

### Solution to Problem

According to an aspect of the present invention, there is provided an information processing device including: a person identifying unit configured to identify a person from a captured image obtained by imaging an imaging area; a calculation unit configured to calculate an expected value for each attribute on the basis of the number of persons for each attribute of the identified person and a reference customer transaction for each attribute; and a content identifying unit configured to identify content based on an attribute selected on the basis of the calculated expected value.

According to another aspect of the present invention, there is provided a display system including: a person identifying unit configured to identify a person from a captured image obtained by imaging an imaging area; a calculation unit configured to calculate an expected value for each attribute on the basis of the number of persons for each attribute of the identified person, a reference customer transaction for each attribute, and a conversion rate; a content identifying unit configured to identify content based on an attribute selected on the basis of the calculated expected value; and a display device configured to display the identified content.

According to another aspect of the present invention, there is provided an information processing method that is performed by a computer, the information processing method including: a person identifying step of identifying a person from a captured image obtained by imaging an imaging area; a calculation step of calculating an expected value for each attribute on the basis of the number of persons for each attribute of the identified person and a reference customer transaction for each attribute; and a content identifying step of identifying content based on an attribute selected on the basis of the calculated expected value.

### Advantageous Effects of Invention

According to the present invention, it is possible to perform sales promotion on a person who is most likely to be profitable to a seller.

### BRIEF DESCRIPTION OF DRAWINGS

FIG. 1 is a diagram schematically illustrating a configuration of a display system according to an embodiment of the present invention.

FIG. 2 is a block diagram schematically illustrating a hardware configuration of an information processing device according to the embodiment of the present invention.

FIG. 3 is a block diagram schematically illustrating a functional configuration of the information processing device according to the embodiment of the present invention.

FIG. 4 is a diagram schematically illustrating a data structure and a data example of an evaluation table according to the embodiment of the present invention.

FIG. 5 is a diagram illustrating an example of expected values calculated according to the embodiment of the present invention.

FIG. 6 is a flowchart illustrating an operation flow of a display process that is performed by the display system according to the embodiment of the present invention.

FIG. 7 is a diagram illustrating an example of a configuration of an information processing device according to another embodiment of the present invention.

### Description of Embodiments

Hereinafter, an embodiment of the present invention will be described.

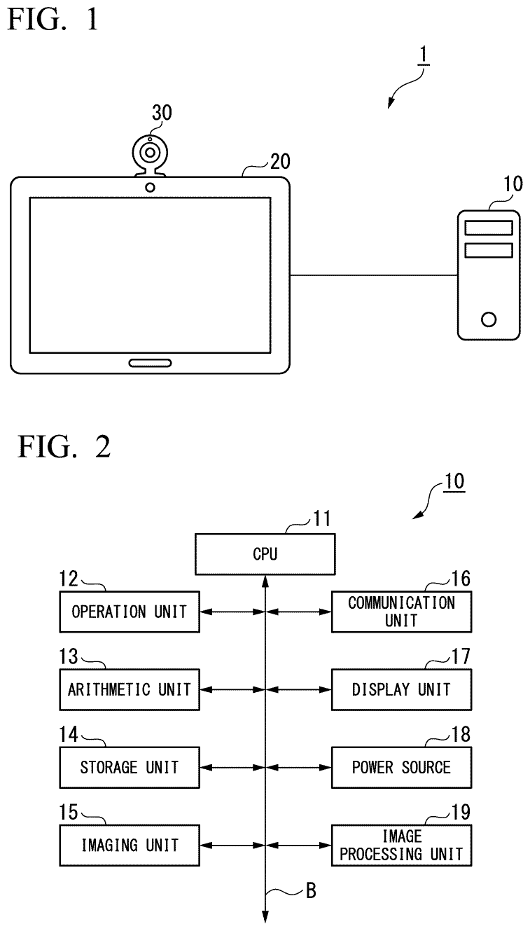

FIG. 1 is a diagram schematically illustrating a configuration of a display system according to an embodiment of the present invention. In this embodiment, a display system 1 is a system that performs display control of content which is to be displayed on an electronic signboard such as a digital signage. Content is for an advertisement, may be a still image or a moving image, and may include vocal sound or not.

In the drawing, the display system 1 includes an information processing device 10, a display device 20, and an imaging device 30. The information processing device 10 and the imaging device 30 are communicatively connected through wired or wireless local area network (LAN) or serial communication. The information processing device 10 and the display device 20 are connected via an image cable for transmitting an image signal.

The information processing device 10 is a computer that performs display control of the display device 20. For example, the information processing device 10 outputs an image signal of content to the display device 20 and displays content on the display device 20.

The display device 20 is a digital signage that displays content for an advertisement on a display screen thereof.

The imaging device 30 is installed in the vicinity of the display device 20 and images an imaging area in the vicinity of the display device 20. The imaging area is, for example, an area in which the display screen of the display device 20 is visible in front of the display screen of the display device 20. The imaging device 30 generates a captured image by imaging the imaging area and transmits the generated captured image to the information processing device 10. The imaging device 30 may be incorporated into the display device 20 or may be an external device that is installed outside of the display device 20.

In this embodiment, the information processing device 10, the display device 20, and the imaging device 30 are described as separate devices, but the present invention is not limited thereto. The functions of the information processing device 10 or the imaging device 30 may be provided in the display device 20.

FIG. 2 is a block diagram schematically illustrating a hardware configuration of the information processing device according to the embodiment of the present invention. In the drawing, the information processing device 10 includes a central processing unit (CPU) 11, an operation unit 12, an arithmetic unit 13, a storage unit 14, an imaging unit 15, a communication unit 16, a display unit 17, a power source 18, and an image processing unit 19. The CPU 11, the operation unit 12, the arithmetic unit 13, the storage unit 14, the imaging unit 15, the communication unit 16, the display unit 17, the power source 18, and the image processing unit 19 are communicatively connected to each other via a bus B.

The CPU 11 comprehensively controls the information processing device 10. The CPU 11 transmits commands to the constituents of the information processing device 10 via the bus B.

The operation unit 12 is an interface for receiving an operation input from a user. The operation unit 12 includes a mouse, a keyboard, and a touch panel provided on the display unit 17. When the information processing device 10 is incorporated into the display device 20, the operation unit 12 is, for example, a light receiver of a remote controller or an operation console.

The arithmetic unit 13 performs an arithmetic process in accordance with a command from the CPU 11.

The storage unit 14 includes a hard disk or a memory and stores various types of data.

The imaging unit 15 is a camera incorporated into the information processing device 10 or a camera installed outside of the information processing device 10 and connected thereto via the communication unit 16.

The communication unit 16 communicates with another device such as the display device 20 or the imaging device 30.

The display unit 17 is a display device such as a liquid crystal display or an organic electroluminescence (EL) display and displays various types of data.

The power source 18 supplies electric power to the constituents of the information processing device 10.

The image processing unit 19 performs image processing in accordance with a command from the CPU 11.

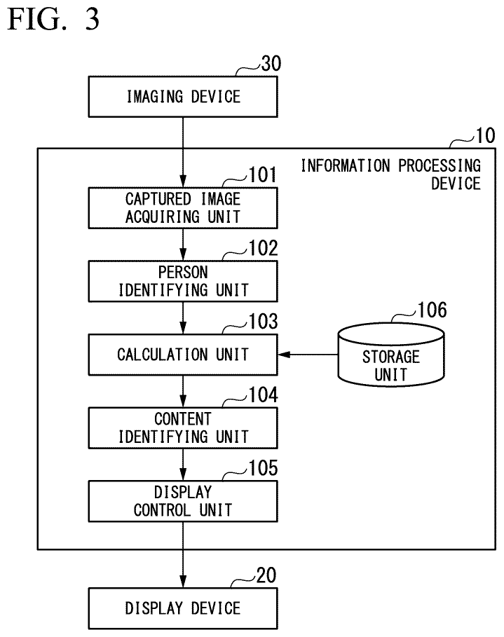

FIG. 3 is a block diagram schematically illustrating a functional configuration of the information processing device according to the embodiment of the present invention.

The information processing device 10 includes a captured image acquiring unit 101, a person identifying unit 102, a calculation unit 103, a content identifying unit 104, a display control unit 105, and a storage unit 106.

The captured image acquiring unit 101 acquires a captured image obtained by imaging the imaging area by receiving the captured image from the imaging device 30. The captured image acquiring unit 101 is realized by the communication unit 16.

The person identifying unit 102 identifies a person from the captured image. The person identifying unit 102 analyzes attributes (age and sex in this embodiment) of each person identified from the captured image. The person identifying unit 102 may analyze the attributes from a face image of each person or may analyze the attributes from clothes of each person. The person identifying unit 102 is realized by the image processing unit 19.

The calculation unit 103 calculates an expected value for each attribute on the basis of the number of persons for each attribute of the identified person and a reference customer transaction for each attribute.

The calculation unit 103 calculates an expected value for each attribute on the basis of the number of persons for each attribute of the identified person, the reference customer transaction for each attribute, and a conversion rate for each attribute. The expected value is a value obtained by quantifying a likelihood that a person will be profitable to a product seller who is an advertiser. In other words, the expected value is an extent to which a customer visits a store and affects sales. For example, the calculation unit 103 calculates an expected value for each attribute on the basis of the number of persons and the reference customer transaction and the conversion rate stored in the storage unit 106. Specifically, the calculation unit 103 calculates the expected value for each attribute by calculating a product of the number of persons, the reference customer transaction, and the conversion rate. The calculation unit 103 is realized by the arithmetic unit 13. Here, the reference customer transaction is a value determined on the basis of a result value of a purchase price for each attribute and may employ, for example, an average value (of which the unit is “yen”) of the result values of the purchase prices for each attribute. The reference customer transaction may be the average value of the result values of the purchase prices for each attribute or may be a value determined according to the average value of the result values.

The content identifying unit 104 identifies content based on an attribute selected on the basis of the calculated expected value. For example, the content identifying unit 104 identifies content based on an attribute indicating that the expected value is the highest. Here, the content identifying unit 104 identifies content based on an attribute with the higher CVR when a difference between the highest expected value and another expected value is equal to or less than a first threshold value α and a difference in CVR based on the attribute is equal to or greater than a second threshold value β. The content identifying unit 104 is realized by the CPU 11.

The display control unit 105 reads the identified content from the storage unit 106 and outputs an image signal of the read content to the display device 20. Accordingly, the display control unit 105 causes the display device 20 to display the identified content. The display control unit 105 is realized by the CPU 11 and the communication unit 16.

The storage unit 106 stores various types of data for display control of the display device 20. For example, the storage unit 106 stores content of each advertisement to be displayed on the display device 20. The storage unit 106 stores attributes corresponding to the content in advance. Attributes corresponding to content indicate target attributes of persons for the content of an advertisement (or a product). The storage unit 106 stores an evaluation table in which an average customer transaction (the reference customer transaction) and a conversion rate for each attribute of a person are arranged. The storage unit 106 is realized by the storage unit 14.

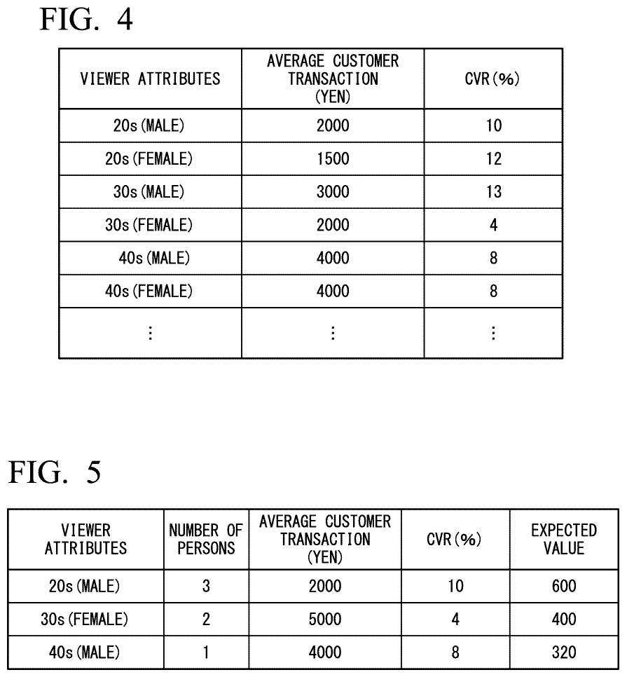

FIG. 4 is a diagram schematically illustrating a data structure and a data example of the evaluation table according to the embodiment of the present invention.

As illustrated in the drawing, the evaluation table includes entries of a viewer attribute, an average customer transaction, and a CVR. The viewer attribute is attributes of a person such as age and sex. The average customer transaction is an average value (of which the unit is “yen”) of the result values of the purchase prices. The CVR is a conversion rate (of which the unit is “% (percentage)”) indicating a ratio of viewers having purchased a product to viewers having viewed the corresponding advertisement. The CVR is, for example, a result value in an online shop other than an actual shop. When there is no online shop, a value obtained by dividing the number of customers having purchased a product by the total number of customers may be used instead of the CVR. The evaluation table is periodically updated.

In the example illustrated in the drawing, the average customer transaction of a viewer attribute “20s (male)” is “2000 yen,” and the CVR thereof is “10%.” The attribute “20s (male)” means “males in 20s,” and each attribute is similarly referred to as “age (sex)” in the following description. The average customer transaction of a viewer attribute “20s (female)” is “1500 yen,” and the CVR thereof is “12%.” The average customer transaction of a viewer attribute “30s (male)” is “3000 yen,” and the CVR thereof is “13%.” The average customer transaction of a viewer attribute “30s (female)” is “2000 yen,” and the CVR thereof is “4%.” The average customer transaction of a viewer attribute “40s (male)” is “4000 yen,” and the CVR thereof is “8%.” The average customer transaction of a viewer attribute “40s (female)” is “4000 yen,” and the CVR thereof is “8%.”

Details of a process of calculating an expected value will be described below in conjunction with a specific example. First, the person identifying unit 102 analyzes attributes (age and sex) of each person identified from the captured image. Then, the person identifying unit 102 calculates the number of persons for each attribute. Subsequently, the calculation unit 103 reads the average customer transaction and the CVR corresponding to each analyzed attribute from the evaluation table stored in the storage unit 106. Then, the calculation unit 103 calculates the expected value for each attribute using following expression (1).

$$Expected value = number of persons \times average customer transaction \times CVR \qquad ( 1 )$$

FIG. 5 is a diagram illustrating an example of expected values calculated according to the embodiment of the present invention.

In the example illustrated in the drawing, an example of expected values of attributes which are calculated when three 20s males, two 30s females, and one 40s males are identified from a captured image is illustrated. As illustrated in the drawing, the expected value of the attribute “20s (male)” is threex2000 yen×0.1 (10%)=600. The expected value of the attribute “30s (female)” is two×5000 yen×0.04 (4%)=400. The expected value of the attribute “40s (male)” is one×4000 yen×0.08 (8%)=320. Accordingly, in this example, the expected value of the attribute “20s (male)” is the highest.

Accordingly, in this example, the content identifying unit 104 identifies content of advertisements corresponding to the attribute “20s (male).” Then, the display control unit 105causes the display device 20 to display the identified content. Accordingly, it is possible to promote sales to three persons of the attribute “20s (male).” As a result, it is possible to enhance a likelihood that the persons of the attribute “20s (male)” having viewed the content of advertisements will purchase products of the advertisements and cause a high profit to a seller.

The calculation unit 103 may calculate the expected value with weights added to the average customer transaction and the CVR. For example, it is conceivable that the weight of the CVR be increased when a seller focuses on visiting of customers and the weight of the average customer transaction be increased when the seller focuses on sales.

Operations of the display system 1 will be described below.

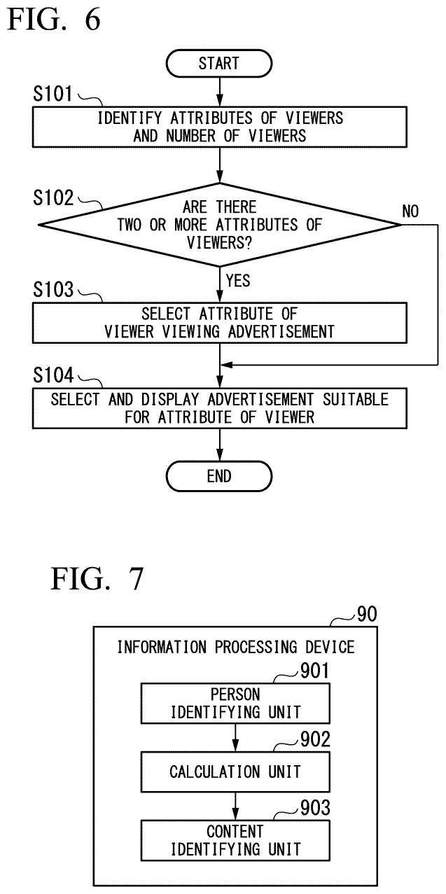

FIG. 6 is a flowchart illustrating an operation flow of a display process that is performed by the display system according to the embodiment of the present invention.

The display device 20 displays content of a predetermined default advertisement in a normal state. The advertisement displayed on the display device 20 is not particularly limited as long as it is for sales promotion. The information processing device 10 performs the operation flow illustrated in the drawing when currently displayed content ends and content to be displayed next is selected.

First, the captured image acquiring unit 101 acquires a captured image obtained by imaging a front of the display device 20 from the imaging device 30. Then, the person identifying unit 102 identifies a person from the captured image. At this time, when there are two or more persons in the captured image, the person identifying unit 102 identifies all the persons. Subsequently, the person identifying unit 102 identifies attributes of each identified person and the number of persons for each attribute (Step S101). Subsequently, the person identifying unit 102 determines whether there are two or more identified attributes (Step S102). When the number of identified attributes is one (Step S102: NO), the operation flow proceeds to the process of Step S104.

On the other hand, when the number of identified attributes is two or more (Step S102: YES), the calculation unit 103 calculates an expected value of each identified attribute. Then, the content identifying unit 104 selects an attribute with the highest expected value (Step S103). Here, when a difference between the highest expected value and another expected value is equal to or less than a first threshold value a and a difference in CVR based on the attribute is equal to or greater than a second threshold value B, the content identifying unit 104 selects an attribute with the higher CVR. Subsequently, the content identifying unit 104 identifies content of an advertisement based on the selected attribute and reads the content from the storage unit 106. Then, the display control unit 105 reads an image signal of the read content to the display device 20 and causes the display device 20 to display the content (Step S104). Thereafter, the operation flow ends.

In this way, the display system 1 according to this embodiment includes the person identifying unit 102 configured to identify a person from a captured image obtained by imaging an imaging area, the calculation unit 103 configured to calculate an expected value for each attribute on the basis of the number of persons for each attribute of the identified person and a reference customer transaction for each attribute, the content identifying unit 104 configured to identify content based on an attribute selected on the basis of the calculated expected value, and the display device 20 configured to display the identified content.

With this configuration, it is possible to display content of an advertisement for a person whose sales is predicted to be high when the person purchases a product. That is, it is possible to promote sales for a person who is most likely to be profitable to a seller of a product who is an advertiser.

The calculation unit 103 calculates the expected value for each attribute additionally on the basis of a conversion rate for each attribute of the identified person. With this configuration, it is possible to promote sales for a person who is highly likely to purchase a product when the person views the content of advertisement. By using the conversion rate, data with high reliability can be used for the likelihood of purchase.

The display system 1 further includes the storage unit 106 configured to store the attributes, the average customer transactions, and the conversion rates. The calculation unit 103 calculates the expected value for each attribute on the basis of the number of persons and the average customer transactions and the conversion rates stored in the storage unit 106. With this configuration, by storing the attributes, the average customer transactions, and the conversion rates in advance, it is possible to decrease a process load for calculating the expected values and to calculate the expected values for a relatively short time.

The calculation unit 103 calculates the expected value for each attribute by calculating a product of the corresponding number of persons, the corresponding average customer transaction, and the corresponding conversion rate. With this configuration, it is possible to more accurately calculate the expected values contributing to a profit to a seller.

The content identifying unit 104 identifies content based on an attribute indicating the highest expected value. With this configuration, it is possible to promote sales for a person who is most likely to be profitable to a seller.

The content identifying unit 104 identifies content based on an attribute with the higher conversion rate when a difference between the highest expected value and another expected value is equal to or less than a first threshold value and a difference in conversion rate based on the attribute is equal to or greater than a second threshold value. With this configuration, when a difference between the expected values is small, it is possible to promote sales for a person who is highly likely to purchase a product.

FIG. 7 is a diagram illustrating an example of a configuration of an information processing device according to another embodiment of the present invention.

An information processing device 90 illustrated in the drawing includes a person identifying unit 901, a calculation unit 902, and a content identifying unit 903.

The person identifying unit 901 identifies a person from a captured image obtained by imaging an imaging area.

The calculation unit 902 calculates an expected value for each attribute on the basis of the number of persons for each attribute of the identified person and the reference customer transaction for each attribute.

The content identifying unit 903 identifies contents based on an attribute which is selected on the basis of the calculated expected values.

Position detection may be performed by recording a program for realizing the functions of the information processing device illustrated in FIG. 3 on a computer-readable recording medium and causing a computer system to read and execute the program recorded on the recording medium. The “computer system” mentioned herein includes an OS or hardware such as peripherals.

The “computer system” includes a homepage provision environment (or display environment) when a WWW system is used.

The “computer-readable recording medium” means a portable medium such as a flexible disk, a magneto-optical disc, a ROM, or a CD-ROM or a storage device such as a hard disk incorporated into the computer system. The “computer-readable recording medium” includes a medium that holds a program for a predetermined time such as a volatile memory in a computer system serving as a server or a client. The program may be for realizing some of the aforementioned functions or may be for realizing the aforementioned functions in combination with a program stored in advance in the computer system. The program may be stored in a predetermined server, and the program may be delivered (downloaded or the like) via a communication line in response to a request from another device.

While an embodiment of the present invention has been described above with reference to the drawings, a specific configuration of the present invention is not limited to the embodiment and includes design or the like without departing from the gist of the present invention.

For example, in the aforementioned embodiment, one piece of content is displayed on the display device 20, but the present invention is not limited thereto. The display screen of the display device 20 may be divided into a plurality of display areas, and a plurality of pieces of content may be displayed in the display areas. When a plurality of pieces of content are displayed, the display control unit 105 may sequentially display the pieces of contents such that a piece of content corresponding to an attribute with a higher expected value in a larger display area. For example, when the display screen is divided into three display areas with different sizes, the display control unit 105 displays a piece of content corresponding to an attribute with the highest expected value in the largest display area, displays a piece of content corresponding to an attribute with the secondly highest expected value in the secondly largest display area, and displays a piece of content corresponding to an attribute with the thirdly highest expected value in the smallest display area. Alternatively, the display control unit 105 may display a plurality of pieces of content corresponding to an attribute with the highest expected value in the display areas.

In the aforementioned embodiment, the expected values for all the pieces of content of all the advertisements are calculated using a single evaluation table, but the present invention is not limited thereto, and the evaluation table may be prepared for each category of products (for example, a suit, shoes, or cosmetics) to be advertised. When the evaluation table for each category is used, the calculation unit 103 may calculate an expected value of each attribute for each piece of content.

In the aforementioned embodiment, the person identifying unit 102 identifies attributes of all persons identified from the captured image, but the present invention is not limited thereto, and attributes of only persons viewing the display device 20 (for example, persons facing forward) out of the persons in the captured image may be identified.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### Reference Signs List

1 Display system
10, 90 Information processing device
101 Captured image acquiring unit
102, 901 Person identifying unit
103, 902 Calculation unit
104, 903 Content identifying unit
105 Display control unit
106 Storage unit
20 Display device
30 Imaging device

What is claimed is:

1. An information processing device comprising:
a person identifying unit configured to identify a person from a captured image obtained by imaging an imaging area;
a calculation unit configured to calculate an expected value for each attribute on the basis of the number of persons for each attribute of the identified person and a reference customer transaction for each attribute; and
a content identifying unit configured to identify content based on an attribute selected on the basis of the calculated expected value.

2. The information processing device according to claim 1, wherein the calculation unit calculates the expected value for each attribute additionally on the basis of a conversion rate for each attribute.

3. The information processing device according to claim 2, further comprising:
a storage unit configured to store the attributes, the reference customer transactions, and the conversion rates,
wherein the calculation unit calculates the expected value for each attribute on the basis of the number of persons and the reference customer transactions and the conversion rates stored in the storage unit.

4. The information processing device according to claim 2, wherein the calculation unit calculates the expected value for each attribute by calculating a product of the corresponding number of persons, the corresponding reference customer transaction, and the corresponding conversion rate.

5. The information processing device according to claim 1, wherein the content identifying unit identifies content based on an attribute indicating the highest expected value.

6. The information processing device according to claim 2, wherein the content identifying unit identifies content based on an attribute with the higher conversion rate when a difference between the highest expected value and another expected value is equal to or less than a first threshold value and a difference in conversion rate based on the attribute is equal to or greater than a second threshold value.

7. A display system comprising:
a person identifying unit configured to identify a person from a captured image obtained by imaging an imaging area;
a calculation unit configured to calculate an expected value for each attribute on the basis of the number of persons for each attribute of the identified person, a reference customer transaction for each attribute, and a conversion rate;
a content identifying unit configured to identify content based on an attribute selected on the basis of the calculated expected value; and
a display device configured to display the identified content.

8. An information processing method that is performed by a computer, the information processing method comprising:
a person identifying step of identifying a person from a captured image obtained by imaging an imaging area;
a calculation step of calculating an expected value for each attribute on the basis of the number of persons for each attribute of the identified person and a reference customer transaction for each attribute; and
a content identifying step of identifying content based on an attribute selected on the basis of the calculated expected value.
